(19) United States
(12) Patent Application Publication
(10) Pub. No.: US 2007/0067265 A1
(43) Pub. Date: Mar. 22, 2007

(54) Using one extensive portlet rather than multiple small portlets

(75) Inventors: Harry C. Husfelt JR., Tuscon, AZ (US); William J. Scheid III, Tuscon, AZ (US)

Correspondence Address: CANADY & LORTZ LLP- IBM, 2540 HUNTINGTON DRIVE, SUITE 205, SAN MARINO, CA, 91108, US

(73) Assignee: International Business Machines Corporation, San Jose, CA (US)

(21) Appl. No.: 11/232,278

(22) Filed: Sep. 21, 2005

(51) Int. Cl. G06F 17/30

(52) U.S. Cl. 707/3

(57) ABSTRACT

Systems and methods are described that can be applied in an optimized implementation and maintenance of a portal-based user interface of a software application. A portal-based user interface employing a single portlet class can behave differently based on configuration settings and run time events, creating a distinction between a portlet (the window visible to user) and the portlet class that interacts with the user. The invention can also provide for JSP (Java Server Page) switching, the display of different JSPs in the same portlet class. Management of back-end server connections can be provided in a connection manager comprising a class that can permit multiple portlets to use a common connection to a back-end server.

### BACKGROUND OF THE INVENTION

1. Field of the Invention

This invention relates to user interfaces for Web-based software applications. Particularly, this invention relates to Web-based user interfaces for software applications employing such functions as administration of a server of an application.

2. Description of the Related Art

Portals are a well known as Web-based technology which operate to deliver content and services to a remote computer through a browser interface. Typically, web portals offer a broad array of resources and services, such as news and information, e-mail, forums, search engines, and on-line shopping malls. Some examples of public web portals include AOL amd YAHOO that provided a variety of information and services to users. In addition, an enterprise portal may provides similar types of information to users for a particular company or business. Accordingly, an enterprise portal may service a company's internal network, e.g. intranet which may include computer and remote network access through an Internet virtual private network (VPN) and/or a local network. Thus, portal technology may be employed in network software applications (e.g. the International Business Machines TIVOLI Storage Manager) that utilize a Web-based user interface, e.g. a network storage manager. For example, portal technology may be used for the user interface for administration and application server functions in such a network software application.

A portlet is a Web component that processes requests and generates dynamic content for a remote user. Portals may use portlets as pluggable user interface components to provide a presentation layer to information system users. Many vendors have created different application programming interfaces (APIs) for portlets. This variety of incompatible interfaces has resulted in difficulties for application providers, portal customers, and portal server vendors. To alleviate some of these difficulties, JSR (Java Specification Request) 168, the Portlet Specification, was originated to provide improved interoperability between portlets and portals. JSR 168 defines portlets as Java-based Web components, managed by a portlet container, that process requests and generate dynamic content. Portals use portlets as pluggable user interface components that provide a presentation layer to information systems.

In general, portlets are an encapsulation of content and functionality. Portlets are assembled onto portal pages that, in turn, make up the portlet application. The act of causing a portlet or portal page to appear in a user's Web browser is commonly referred to as launching. When a portal page is sent back to a user's web browser it is called a response web page. The response web page comprises a summary of multiple portlets that provide content to the overall page. The launch of a portlet is adding another container to display additional information. Web pages typically comprise portlets with fixed content and actions that can launch other web pages. There are also web pages that include portlets that can add additional portlets to the web page. This can be called an internal launch. At any given time, a portlet will contain a JAVA Server Page (JSP) page. At first glance, a JSP page looks similar to an HTML (or XML) page. Both contain text encapsulated by tags. (Note that throughout the following description, the terms JSP page and server page may be used interchangeably.) However, HTML provides static content to the overall response, whereas a JSP page provides dynamic content to a web browser when the user requests the web page. For example, a JSP page can lookup the latest stock quote from a server on the Internet, a function beyond the capability of conventional HTML. For example, a JSP page can lookup information from a storage server regarding user, storage status, or other server objects and display that information.

A typical portal-based user interface can contain several portal pages with at least one portlet on each portal page. In most cases, a portal page will contain multiple portlets. One approach to implementing such an application is to provide individual portlet classes, one for each portlet in the interface. Each portlet class would be bound to a specific JSP page. This can result in a great deal of redundant code that is difficult to extend and maintain.

Typically, the purpose of the portal-based user interface is to provide for the interaction of a user with an applications server. The application server is commonly referred to as the back-end server. Each portlet of the interface has its own unique state known as a portlet session. That state can not be shared by other portlets. However, multiple portlets in the application may need a connection to interact with a given back-end server using the same credentials. The interface is often designed such that each portlet establishes an individual connection with the back-end server. However, this can require excessive overhead to maintain the multiple connections to the same back-end server.

In view of the foregoing, there is a need in the art for systems and methods to minimize the number of connections to a back-end server in a portal implementation in network software applications employing Web-based user interfaces. There is further a need for such systems and methods to reduce the overhead required to maintain multiple connections to a back-end server in a portal implementation. There is also a need for such systems and methods to operate without requiring excessive redundant code. These and other needs are met by the present invention as detailed hereafter.

### SUMMARY OF THE INVENTION

The present invention is directed to systems and methods in a software application using portal technology. Various embodiments of the invention can be applied in an optimized implementation and maintenance of a portal-based user interface. Embodiments of the invention employ a single extensive portlet rather than multiple small portlets as in the prior art. Embodiments of the invention allow a remote user event to cause the content of an existing portlet to switch to display new content. The enablement dynamic content of the portlet in this manner provides improved flexibility to a developer of web content. In addition a connection manager can be employed to facilitate a single connection to a back-end server employed by multiple portlets.

A typical embodiment of the invention comprises program instructions for a portlet class for generating an individualized portal page based on user information and configuration information of a back-end server and program instructions for a connection manager for connecting one or more portlets of the portlet class with a common connection to the back-end server. The portlet class can switch among a plurality of server pages displayed to a user without switching the portlet class. Further embodiments can include program instructions for a page manager for determining a server page name of one of the plurality of server pages based on a portlet type of the individualized portal page and an event and the portlet type comprises portlet components described to the page manager in a portlets descriptor file. The connection manager can generate a connection token to control use of the common connection such that the connection token is passed only to one or more launched portlets of the one or more portlets of the portlet class.

The portlet type components can include a variety of elements. For example, the portlet type components can include a single primary server page. They can include the plurality of server pages where the server pages include a single primary server page and a set of alternate server pages. The portlet type components can also include a help topic for each of the plurality of server pages, the help topic being displayed in response to a use help request. Further, the portlet type components can include a list of a set of portal pages capable of being launched from the configuration information of the back-end server. In addition, the portlet type components include a set of portlets and a name of a control structure used by the individualized portal page to create and initialize the control structure.

Similarly, a typical method of the invention comprises generating an individualized portal page with a portlet class, the individualized portal page based on user information and configuration information of a back-end server and connecting one or more portlets of the portlet class to the back-end server using a common connection with a connection manager. The method may be further modified consistent with the computer program embodiment of the invention.

### BRIEF DESCRIPTION OF THE DRAWINGS

Referring now to the drawings in which like reference numbers represent corresponding parts throughout:

FIG. 1A illustrates an exemplary computer system that can be used with embodiments of the present invention;

FIG. 1B illustrates an exemplary computer network comprising one or more computer systems that can be used with embodiments of the present invention;

FIG. 2A illustrates the relationship between the pages and portlets in an exemplary embodiment;

FIG. 2B illustrates the operation of portlet classes and a connection manager in an exemplary Web-based user interface application in an embodiment of the invention;

FIG. 3 illustrates a typical page comprising a plurality of portlets view on a user computer; and

FIG. 4 is a flowchart showing an exemplary method of the invention.

### DETAILED DESCRIPTION OF THE PREFERRED EMBODIMENT

1. Overview

Embodiments of the invention encompass a portal-based user interface employing a single portlet class (i.e. an extensive portlet) that can behave differently based on configuration settings and run time events rather than using multiple small portelets. This creates a distinction between a portlet (the window or sub-window visible to user) and the portlet class that interacts with the user. There is no longer a one-to-one relationship between a portlet and a visible window or sub-window as in a conventional implementation. Furthermore, embodiments of the invention may also provide for the display of different JSPs in the same portlet. This can be termed “JSP Switching.”

Further embodiments of the invention may also involve managing back-end server connections in a connection manager, a class that can permit multiple portlets to use a common connection to a back-end server rather than a single connection for each portlet. This permits a portlet to delay the making the connection until it is needed and avoids unnecessary connections which may occur if a user decides to just close the portlet. In addition, this accounts for the case when a user might close the parent portlet making it unclear who manages connection cleanup.

2. Hardware Environment

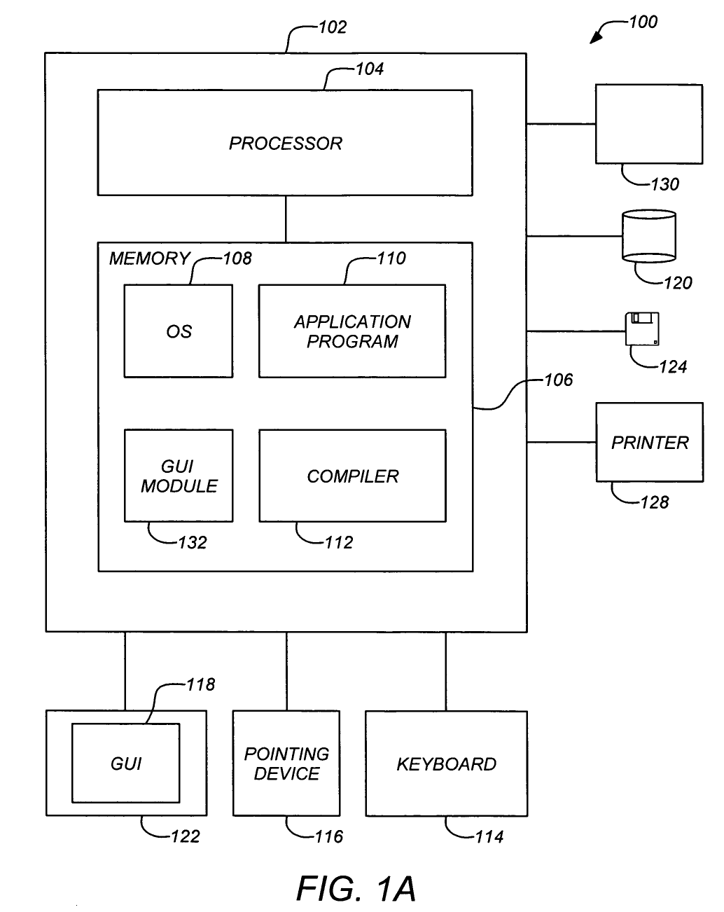

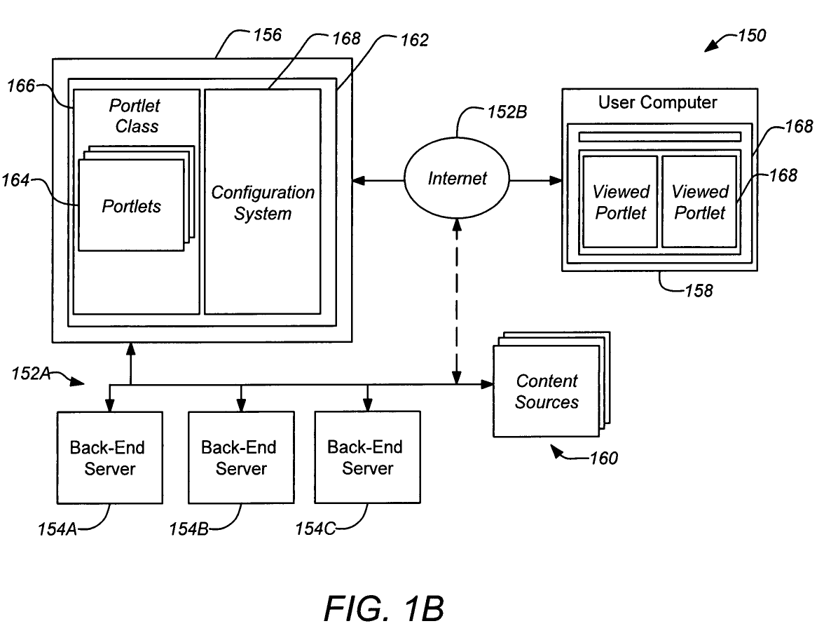

FIG. 1 illustrates an exemplary computer system 100 that can be used to implement embodiments of the present invention. The computer 102 comprises a processor 104 and a memory 106, such as random access memory (RAM). The computer 102 is operatively coupled to a display 122, which presents images such as windows to the user on a graphical user interface 118. The computer 102 may be coupled to other devices, such as a keyboard 114, a mouse device 116, a printer 128, etc. Of course, those skilled in the art will recognize that any combination of the above components, or any number of different components, peripherals, and other devices, may be used with the computer 102.

Generally, the computer 102 operates under control of an operating system 108 (e.g. z/OS, OS/2, LINUX, UNIX, WINDOWS, MAC OS) stored in the memory 106, and interfaces with the user to accept inputs and commands and to present results, for example through a graphical user interface (GUI) module 132. Although the GUI module 132 is depicted as a separate module, the instructions performing the GUI functions can be resident or distributed in the operating system 108, the computer program 110, or implemented with special purpose memory and processors. The computer 102 also implements a compiler 112 which allows an application program 110 written in a programming language such as COBOL, PL/1, C, C++, JAVA, ADA, BASIC, VISUAL BASIC or any other programming language to be translated into code readable by the processor 104. After completion, the computer program 110 accesses and manipulates data stored in the memory 106 of the computer 102 using the relationships and logic that was generated using the compiler 112. The computer 102 also optionally comprises an external data communication device 130 such as a modem, satellite link, ethernet card, wireless link or other device for communicating with other computers, e.g. via the Internet or other network.

In one embodiment, instructions implementing the operating system 108, the computer program 110, and the compiler 112 are tangibly embodied in a computer-readable medium, e.g., data storage device 120, which could include one or more fixed or removable data storage devices, such as a zip drive, floppy disc 124, hard drive, DVD/CD-rom, digital tape, etc. Further, the operating system 108 and the computer program 110 comprise instructions which, when read and executed by the computer 102, cause the computer 102 to perform the steps necessary to implement and/or use the present invention. Computer program 110 and/or operating system 108 instructions may also be tangibly embodied in the memory 106 and/or transmitted through or accessed by the data communication device 130. As such, the terms “article of manufacture,” “program storage device” and “computer program product” as may be used herein are intended to encompass a computer program accessible and/or operable from any computer readable device or media.

Embodiments of the present invention are generally directed to any software application program 110 employing a Web-based user interface. Particularly, the software application program 110 can operate over a distributed computer system, e.g. a network. The network may encompass one or more computers connected via a local area network or Internet connection (which may be public or secure, e.g. through a VPN connection).

FIG. 1B illustrates a typical distributed computer system 150 which may be employed in an typical embodiment of the invention. Such a system 150 comprises a plurality of computers 102, e.g. as described in FIG. 1A, which are interconnected through respective communication devices 130 in one or more networks 152A, 152B. The one or more networks 152A, 152B may be entirely private (such as the local area network 152A within a business facility) or part or all of the networks 152A, 152B may exist publicly (such as through a virtual private network (VPN) operating on the Internet 152B). Furthermore, one or more of the computers may be specially prepared and/or designed to function as portlet server 156 coupled to one or more back-end server 154A-154C facilitating a variety of services provided to a user computer 158. Furthermore, functions of the portlet server 156 may be distributed across a plurality of computers interconnected in the networks 152A, 152B. In addition, the potlet server 156 and the one or more back-end server 154A-154C may access additional content sources 160 as necessary in order to provide services to the user computer 158. Although the private network 152A and the public network 152B (e.g. the Internet) are typically isolated from each other, variations can operatate with one or more back-end servers 154A-154C interconnected through the public network 152B. Similarly, one or more of the user computers 158 may be interconnected to the portlet server 156 through a private network 152A.

A portal program 162 is stored in memory of portlet server 156, which can be any program capable of obtaining and aggregating web content into portlets of a portal page provided to the user computer 158. The portal program 162 includes one or more portlets 164 which are part of a portlet class 166 and a configuration system 168. The portlets 164 can have previously stored content or receive/obtain content from back-end servers 154A-154C in any known manner. The configuration system 168 is used, e.g. by an administrator, to configure the portlet class 166 and the one or more portlets 164.

Those skilled in the art will recognize many modifications may be made to this hardware environment without departing from the scope of the present invention. For example, those skilled in the art will recognize that any combination of the above components, or any number of different components, peripherals, and other devices, may be used with the present invention meeting the functional requirements to support and implement various embodiments of the invention described herein.

3. Portlet Classes and Managing Back-End Server Connections

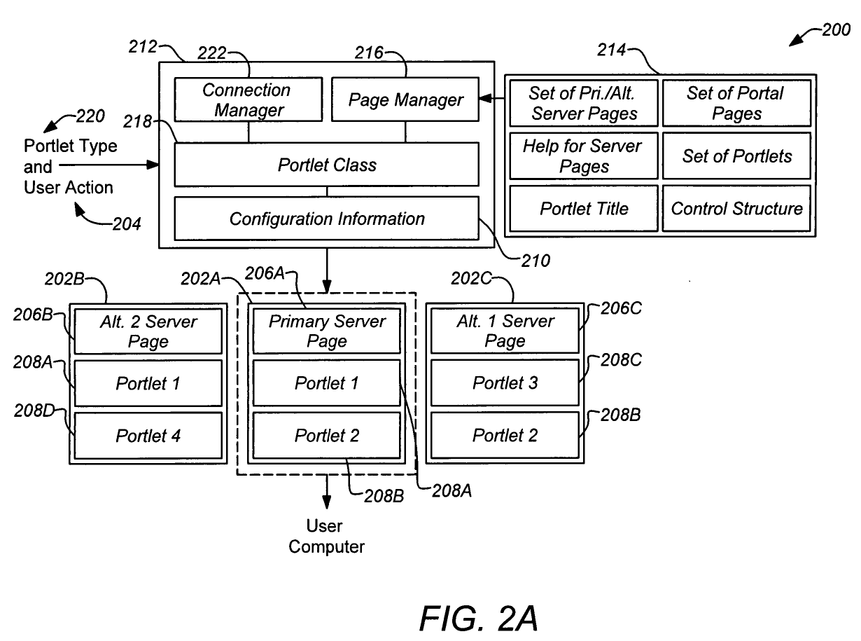

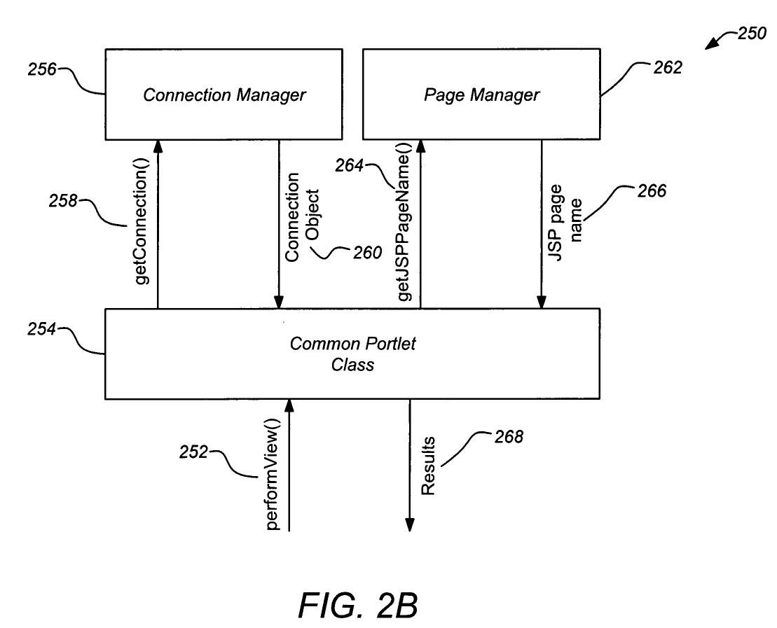

FIG. 2A illustrates the relationship between the pages and portlets in an exemplary system 200. In general, server pages 206A-206C and portlets 208A-208D are launched in response to some event generated by a user action 204. A typical individualized portal page 202A-202C comprises one or more portlets. The launch of an individualized portal page 202A-202C can be described as a special case of the launch of a portlet. Although the mechanics of the initial launch are different, the remaining processing is the same as an individual portlet launch. This case can be considered as a mass portlet launch.

A JSP server page switch can also be performed in response to a user generated event 204. The developer of an application may begin the implementation of this solution by defining the set of portlets that the user will see and the events that will trigger them. Each event can trigger the display of an alternative page as will be detailed hereafter.

Embodiments of the invention may comprise several parts. Installation configuration information 210 within the portlet application 212 of the portlet server that configures the set of portlets 208A-208D to the portlet server can be used. In addition, a portlets descriptor file 214 that describes each portlet 208A-208D of the application 212 can be employed as well as a page manager 216 and a common portlet class 218. These elements are described in further detail hereafter.

The installation configuration information 210 can include a unique identifier, referred to as the portlet type 220, assigned to each unique portlet 208A-208D (the window visible to the user) of the application. This portlet type 220 can be used to customize the behavior of the common portlet class 218. The common portlet class 218 can be specified as part of the application's portlet definitions during installation onto a portlet server. The various portlet definitions can each have configuration parameters (PortletSettings) which include the portlet type 220.

The portlets descriptor file 214 can use an XML syntax and comprises a description of each portlet type. The elements of the descriptor file 214 are used to describe the components of each portlet type to the page manager 216. The basic components of a typical portlet type 220 included in the descriptor file 214 are detailed below. Additional components can be added to support unique application requirements.

First, embodiments of the invention employ a primary JSP server page 206A. One and only one primary JSP server page 206A can be defined; this is the initial JSP page displayed in the individualized portal page 202A. Furthermore, the descriptor file 214 includes a set of alternate JSP server pages 206B, 206C and the user event that triggers the JSP switch to cause their display. Thus, a different event is a trigger for each alternate page. The descriptor file 214 also includes the string to be used as the portlet title.

The file also comprises the set of portal pages 202A-202C that can be launched; a portlet can launch zero or more portal pages. This can be thought of as the mass launch of several portlets defined in the descriptor file. Each page is from the application's configuration information 210. In addition, the file 214 includes the set of portlets 208A-208D that can be launched. Each portlet 208A-208D is from the descriptor file 214. Similar to pages, a portlet 208A-208D can launch zero or more portlets.

The name of a control structure to be created and passed to a launched portlet 208A-208D at startup can also be included in the descriptor file 214. When requested, the portlet class 218 uses this information to create and initialize the structure at run time, and store it in the PortletSession for use by the launched portlet 208A-208D.

In addition, each JSP server page 206A-206C can have an associated help topic. When the user requests help, this is the topic that the application will request the help system to display.

The page manager 216 can be implemented as a singleton class to encapsulate the desired behavior. A singleton class is simply a class for which only a single instance can be created. The XML descriptor file 214 is read during initialization of the page manager 216. The page manager 216 can provide methods which give the common portlet class 218 access to its information. For a given portlet type 220, the page manager 216 will return the primary JSP server page 206A to be displayed in the portal page 202A. For a given event (e.g. user action 204) and portlet type 220, the page manager 216 will return an alternate JSP server page 206B, 206C to be displayed in the portal page.

The common portlet class 218 is the main entry point of a user interface portion of the application 212. The portal server on which the interface is running will invoke the class 218 when a user performs some action at his browser. Based on information 210 contained in the configuration of the portlets, the portlet class 218 determines which portlet type 220 is being invoked. The portlet class 218 first determines the event that the user action represents. If the event requires the display of the primary JSP server page 206A, the portlet class performs the operations to return that JSP server page 206A to the user's browser. If the event requires the display of an alternate JSP server page 206B, 206C, the portlet class 218 performs the operations to display the alternate JSP server page 206B, 206C. Thus, the single portlet class 218 can switch between multiple JSP pages 206A-206C. An exemplary process of page switching is further detailed as follows.

The common portlet class 218 requests the page manger 216 to determine how to respond to the user request. The page manager 216 returns the name of the alternate JSP server page 206B, 206C to display to the user. The page manager 216 also returns information (e.g. a bean in the XML description) to provide some initial content to the JSP server page. The bean is dynamically loaded before the JSP server page and placed in the portlet session descriptor. The bean loads and processes any content that is necessary for the JSP server page to display. For example, a bean may contact a server for the NY Stock exchange to determine the latest stock price of IBM. The JSP server page, using the preloaded bean, formats the information to display to the user. By employing the single portlet class, a disconnection from content is enabled with embodiments of the invention. In a conventional system, the portlet class does everything to process the user request. Thus one portlet class must be employed for the content to be displayed for each portlet. Embodiments of the invention employ a portlet class that includes enough intelligence (with some assistance like a page manager) to provide different content based on the user request. In contrast, the current standard does not provide a mechanism to enable this sort of dynamic switching of pages.

As part of operations to return a JSP server page 206A-206C to a user's browser, the portlet class 218 will determine if it must create a control structure by calling the page manager 216 to support the display of the JSP server page 206A-206C. When required, the portlet class 218 uses the information provided by page manager 216 to create and initialize the control structure, and store it in the PortletSession with the given name.

In some instances, the portlet class 218 may determine that the user has requested the display of a help topic for the JSP server page 206A-206C being currently displayed in the portal page 202A-202C. In that case, the portlet class 218 obtains from the page manager 216 the help topic for the current JSP given the portlet type 220 and current event (e.g. user action 204). The portlet class 218 initiates the display of that help topic by the help system.

The connection manager 222 manages a set of connections with one or more back-end servers. A portlet can create a connection with a given server by calling the createConnection( ) method with the proper parameters. The createConnection( ) method generates a globally unique identifier for this new connection known as the connection token. The connection token is stored in the PortletSession. If a portlet launches another portlet or page, the connection token in passed to the new portlets as one of the parameters of the launch operation Portlets gain access to a previously created connection to a given server by calling the getConnection( ) method with the connection token associated with the corresponding connection.

FIG. 2B illustrates the operation of portlet classes and a connection manager in an exemplary Web-based user interface 250 in an embodiment of the invention. Each portlet in a page comprises a view, determined from the performView( ) method request 252 provided to the portlet class 254. The portlet class 254 interacts with the connection manager 256 through the getconnection( ) method request 258. The connection manager 256 maintains a list of connections back to the server delivers a connection object 260 to the portlet class 254 in response to the getconnection( ) method request 258 from the portlet class 254. The page manager 262 comprises a document (e.g. XML) that responds with which JSP page to load in response to a getJspPageName( ) method request 264 from the portlet class 254. The page manager 262 returns the JSP page name 266 to the portlet class 254. The page manager 262 will return the primary JSP page for a given portlet type or an alternate JSP page if a given event is also present with the given portlet type. The portlet type, which may be merely a string that represents an ID in the page manager's configuration file, is important because it determines what initial content to display. The portlet type can be passed in during portlet initialization per the portlet standard. The results 268, including the connection object 260, JSP page name 266 as well as the view parameters from the portlet class 254 in response to the performView method request 252, are provided as control is returned to the portlet engine. The identified JSP server page will then be included in the results 268.

The Page Manager Descriptor File can be an XML document. The syntax of an exemplary file is described here in the XML Schema language, which is also referred to as XML Schema Definition (XSD). The exemplary XML file defines a page manager descriptor file in an embodiment of the invention. Alterations to the exemplary file can be made to tailor it's use to a particular application as understood by those skilled in the art. In addition, the XML file may be interpreted as pseudo code and applied to alternate languages without departing from the scope if the invention.

<?xml version=“1.0” encoding=“UTF-8”?>
<xsd:schema xmlns:xsd=“http://www.w3.org/2001/XMLSchema”>

<xsd:element name=“alternate-jsp”>

<xsd:complexType>

<xsd:sequence>

<xsd:element ref=“title” minOccurs=“0”/>

</xsd:sequence>
<xsd:attribute name=“event” type=“xsd:string” use=“required”/>
<xsd:attribute name=“help” type=“xsd:string” use=“optional”/>
<xsd:attribute name=“page” type=“xsd:string” use=“required”/>

</xsd:complexType>

</xsd:element>
<xsd:element name=“jsppages”>

<xsd:complexType>

<xsd:sequence>

<xsd:element ref=“primary-jsp”/>
<xsd:element ref=“alternate-jsp” minOccurs=“0”

maxOccurs=“unbounded”/>

</xsd:sequence>

</xsd:complexType>

</xsd:element>
<xsd:element name=“launches”>

<xsd:complexType>

<xsd:choice maxOccurs=“unbounded”>

<xsd:element ref=“page”/>
<xsd:element ref=“portlet”/>

</xsd:choice>

</xsd:complexType>

</xsd:element>
<xsd:element name=“page”>

<xsd:complexType>

<xsd:attribute name=“event” type=“xsd:string” use=“required”/>
<xsd:attribute name=“id” type=“xsd:string” use=“required”/>
<xsd:attribute name=“name” type=“xsdstring” use=“required”/>

</xsd:complexType>

</xsd:element>
<xsd:element name=“portlet”>

<xsd:complexType>

<xsd:sequence>

<xsd:element ref=“bean” minOccurs=“0” maxOccurs=“unbounded”/>

</xsd:sequence>
<xsd:attribute name=“event” type=“xsd:string” use=“required”/>
<xsd:attribute name=“type” type=“xsd:string” use=“required”/>

</xsd:complexType>

</xsd:element>
<xsd:element name=“portlets”>

<xsd:complexType>

<xsd:sequence>

<xsd:element ref=“types”/>

</xsd:sequence>
<xsd:attribute name=“name” type=“xsd:string” use=“required”/>

</xsd:complexType>

</xsd:element>
<xsd:element name=“primary-jsp”>

<xsd:complexType>

<xsd:sequence>

<xsd:element ref=“title”/>
<xsd:element ref=“notebook” minOccurs=“0”/>

</xsd:sequence>
<xsd:attribute name=“help” type=“xsd:string” use=“optional”/>
<xsd:attribute name=“page” type=“xsd:string” use=“required”/>

</xsd:complexType>

</xsd:element>
<xsd:element name=“title”>

<xsd:complexType>

<xsd:attribute name=“has-inserts” type=“xsd:string” use=“required”/>
<xsd:attribute name=“key” type=“xsd:string” use=“required”/>
<xsd:attribute name=“resBun” type=“xsd:string” use=“optional”/>

</xsd:complexType>

</xsd:element>
<xsd:element name=“type”>

<xsd:complexType>

<xsd:sequence>

<xsd:element ref=“bean” minOccurs=“0”/>
<xsd:element ref=“jsppages”/>
<xsd:element ref=“launches” minOccurs=“0”/>

</xsd:sequence>
<xsd:attribute name=“name” type=“xsd:string” use=“required”/>

</xsd:complexType>

</xsd:element>
<xsd:element name=“types”>

<xsd:complexType>

<xsd:sequence>

<xsd:element ref=“type” maxOccurs=“unbounded”/>

</xsd:sequence>
<xsd:attribute name=“jspbase” type=“xsd:string” use=“required”/>

</xsd:complexType>

</xsd:element>
<xsd:element name=“bean”>

<xsd:complexType>

<xsd:attribute name=“classname” type=“xsd:string” use=“required”/>
<xsd:attribute name=“name” type=“xsd:string” use=“required”/>

</xsd:complexType>

</xsd:element>

</xsd:schema>

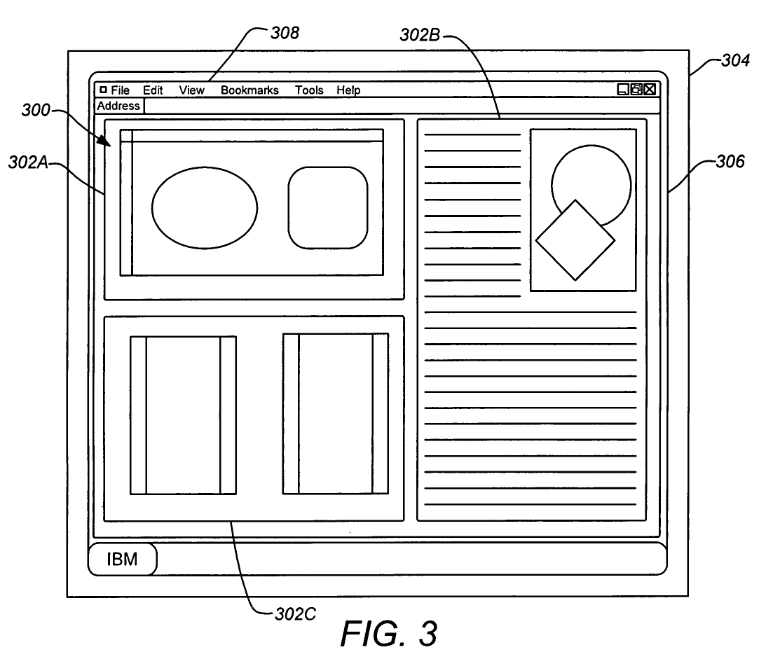

FIG. 3 illustrates a typical page 300 comprising a plurality of portlets 302A-302C viewed on a user computer. The display 304 of the user computer presents the GUI 306 in which the browser 308 is shown to the remote user. As previously detailed, using a single portlet class, the page 300 as well as the incorporated portlets 302A-302C, can be switched without changing the portlet class. For example, a user may be presented with a portlet that includes a list of objects on the storage server, e.g. a list of nodes in a table. Selecting from a group of available actions on the table (or some other means) the user can request to create a new object. This causes the content of the current portlet (displaying the list of nodes) to switch to a wizard to create a new object (e.g. create a new node). Once the user completes the wizard (e.g. creating the new node), the user then returns to the listing of objects (the table of nodes) again. From an alternate second action, the user can launch a new portlet that includes a properties notebook for a given object (e.g. a node BJ). Other alternate actions can cause the page to switch to the JSP page to handle that event.

4. Managing Back-End Server Connections

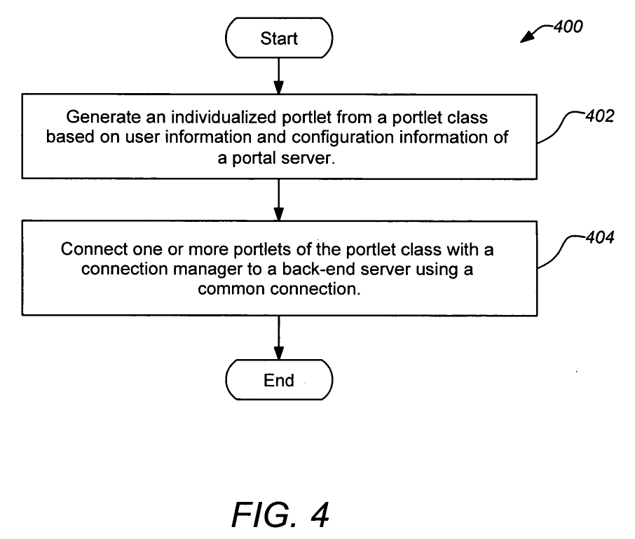

FIG. 4 is a flowchart showing an exemplary method 400 of the invention. The method 400 begins with an operation 402 where an individualized portlet is generated from a portlet class. The individualized portlet is based on user information and configuration information of a portal server. In some embodiments, when launching a new portlet, the portlet engine can also pass some additional context to the new portlet. The additional context in this case, can include a unique identifier to locate an existing connection to the backend using the connection manager. In addition, in operation 404, one or more portlets of the portlet class are connected with a connection manager to a back-end server using a common connection. If a connection does not exist, the connection manager can create a new connection and generate a new unique identifier for the new connection. The method 400 may be further modified consistent with the systems and software applications previously described.

This concludes the description including the preferred embodiments of the present invention. The foregoing description including the preferred embodiment of the invention has been presented for the purposes of illustration and description. It is not intended to be exhaustive or to limit the invention to the precise forms disclosed. Many modifications and variations are possible within the scope of the foregoing teachings. Additional variations of the present invention may be devised without departing from the inventive concept as set forth in the following claims.

What is claimed is:

1. A computer program embodied on a computer readable medium, comprising:
program instructions for a portlet class for generating an individualized portal page based on user information and configuration information of a portal server; and
program instructions for a connection manager for connecting one or more portlets of the portlet class with a common connection to a back-end server.

2. The computer program of claim 1, wherein the portlet class switches among a plurality of server pages displayed to a user without switching the portlet class.

3. The computer program of claim 2, further comprising program instructions for a page manager for determining a server page name of one of the plurality of server pages based on a portlet type of the individualized portal page and an event and the portlet type comprises portlet components described to the page manager in a portlets descriptor file.

4. The computer program of claim 3, wherein the portlet type components include a single primary server page.

5. The computer program of claim 3, wherein the portlet type components include the plurality of server pages, the plurality of server pages comprising a single primary server page and a set of alternate server pages.

6. The computer program of claim 3, wherein the portlet type components include a help topic for each of the plurality of server pages, the help topic being displayed in response to a use help request.

7. The computer program of claim 3, wherein the portlet type components include a list of a set of portal pages, the set of portal pages capable of being launched from the configuration information of the portal server.

8. The computer program of claim 3, wherein the portlet type components include a set of portlets.

9. The computer program of claim 3, wherein the portlet type components include a name of a control structure used by the individualized portal page to create and initialize the control structure.

10. The computer program of claim 1, wherein the connection manager generates a connection token to control use of the common connection such that the connection token is passed only to one or more launched portlets of the one or more portlets of the portlet class.

11. A method, comprising:
generating an individualized portal page with a portlet class, the individualized portal page based on user information and configuration information of a portal server; and
connecting one or more portlets of the portlet class to a back-end server using a common connection with a connection manager.

12. The method of claim 11 wherein the portlet class switches among a plurality of server pages displayed to a user without switching the portlet class.

13. The method of claim 12, further comprising determining a server page name of one of the plurality of server pages with a page manager based on a portlet type of the individualized portal page and an event and the portlet type comprises portlet components described to the page manager in a portlets descriptor file.

14. The method of claim 13, wherein the portlet type components include a single primary server page.

15. The method of claim 13, wherein the portlet type components include the plurality of server pages, the plurality of server pages comprising a single primary server page and a set of alternate server pages.

16. The method of claim 13, wherein the portlet type components include a help topic for each of the plurality of server pages, the help topic being displayed in response to a use help request.

17. The method of claim 13, wherein the portlet type components include a list of a set of portal pages, the set of portal pages capable of being launched from the configuration information of the portal server.

18. The method of claim 13, wherein the portlet type components include a set of portlets.

19. The method of claim 13, wherein the portlet type components include a name of a control structure used by the individualized portal page to create and initialize the control structure.

20. The method of claim 11, wherein the connection manager generates a connection token to control use of the common connection such that the connection token is passed only to one or more launched portlets of the one or more portlets of the portlet class.
